(19) United States
(12) Patent Application Publication
(10) Pub. No.: US 2026/0220931 A1
(43) Pub. Date: Jul. 30, 2026

(54) NEURAL NETWORK TRAINING METHOD AND DEFECT DETECTION METHOD AND APPARATUS

(71) Applicants: Jiasong XIAO, Beijing (CN); Yifei Zhang, Beijing (CN)

(72) Inventors: Jiasong XIAO, Beijing (CN); Yifei Zhang, Beijing (CN)

(73) Assignee: Ricoh Company, Ltd., Tokyo (JP)

(21) Appl. No.: 19/459,514

(22) Filed: Jan. 26, 2026

(30) Foreign Application Priority Data
Jan. 27, 2025 (CN) 202510126445.2

(51) Int. Cl. G06V 10/82; G06N 3/0442

(52) U.S. Cl. CPC G06V 10/82; G06N 3/0442

(57) ABSTRACT

A method of training a neural network is provided. The method includes steps of obtaining labeled defect information of an object and a training image set collected from the object, and obtaining, based on the training image set, feature image sets for representing a plurality of features of the object; inputting the feature image sets into the neural network, utilizing attention mechanism modules in the neural network to carry out local attention generation and global attention generation with respect to the feature image sets, respectively, so as to generate processing results, and creating, based on the processing results, training defect information of the object; and comparing the training defect information of the object and the labeled defect information of the object, so as to train the neural network and adjust parameters of the neural network.

### CROSS-REFERENCE TO RELATED APPLICATIONS

The present disclosure is based on and claims the benefit of priority of Chinese Patent Application No. 202510126445.2 filed on Jan. 27, 2025, the entire contents of which are hereby incorporated by reference.

### BACKGROUND OF THE INVENTION

### 1. Field of the Invention

The present disclosure relates to the field of image processing, and specifically, a method and apparatus for training a neural network as well as a method and apparatus for conducting defect detection by utilizing a neural network.

### 2. Description of the Related Art

In the field of industrial production, the manufactured parts of various industrial products may develop surface defects such as bumps, dents, scratches, abrasions, and so on, due to the influence of production technology, the surrounding environment, and other factors. For example, in the automotive manufacturing industry, the body in white of a vehicle requires a paint layer to achieve the effect of corrosion resistance, protection, and aesthetics. However, because the paint layer is only about 60 μm thick, it may not cover surface defects, thereby severely impacting the function of corrosion resistance and protection and reducing the effect of aesthetics. The quality of the paint layer is a crucial indicator for evaluation of the overall appearance of a vehicle. As a result, during the manufacturing process, it is essential to promptly detect and remove the surface defects on the body in white of a vehicle to ensure that it meets the basic functional requirements and achieves the effect of aesthetics.

In current manufacturing processes, most workshops require manual polishing with respect to the entire body in white of a vehicle by using long and short oilstones. Workers rely on their extensive experience to identify the type and extent of a surface defect, that then may serve as a reference for the subsequent defect repair. However, this kind of defect detection approach inadvertently increases time cost and wastes manpower.

Furthermore, when considering using an image detection approach based on a convolutional neural network to fulfill intelligent and automated defect detection, problems have also been found in regard to the image detection algorithm, such as low accuracy, a high false alarm rate, excessive computational amount, and so forth.

Therefore, a method and apparatus for training a neural network as well as a method and apparatus for performing defect detection by utilizing a neural network are necessary, so as to improve the detection efficiency and reduce the system response time while ensuring the accuracy of the image detection algorithm.

### SUMMARY OF THE INVENTION

In order to solve the above technical problems, according to a first aspect of the present disclosure, a method of training a neural network is provided that includes steps of
obtaining labeled defect information of an object and a training image set collected from the object, and obtaining, based on the training image set, feature image sets for representing a plurality of features of the object;
inputting the feature image sets into the neural network, utilizing attention mechanism modules in the neural network to carry out local attention generation and global attention generation with respect to the feature image sets, respectively, so as to generate processing results, and calculating, based on the processing results, training defect information of the object; and
comparing the training defect information of the object and the labeled defect information of the object, so as to train the neural network and adjust parameters of the neural network.

According to a second aspect of the present disclosure, a method of conducting defect detection by utilizing a neural network is provided that is inclusive of steps of
obtaining a detection image set collected from an object, and obtaining, based on the detection image set, detection feature image sets for representing a plurality of features of the object;
inputting the detection feature image sets into the neural network, and utilizing attention mechanism modules in the neural network to carry out local attention generation and global attention generation with respect to the detection feature image sets, respectively, so as to generate processing results; and
obtaining, based on the processing results, detection defect information of the object.

According to a third aspect of the present disclosure, an apparatus for training a neural network is provided that includes
an obtainment part for obtaining labeled defect information of an object and a training image set collected from the object, and obtaining, based on the training image set, feature image sets for representing a plurality of features of the object;
a calculation part for inputting the feature image sets into the neural network, utilizing attention mechanism modules in the neural network to carry out local attention generation and global attention generation with respect to the feature image sets, respectively, so as to obtain processing results, and calculating, based on the processing results, training defect information of the object; and
a training part for comparing the training defect information of the object and the labeled defect information of the object, so as to train the neural network and adjust parameters of the neural network.

According to a fourth aspect of the present disclosure, an apparatus for conducting defect detection by utilizing a neural network is provided that is inclusive of
an obtainment part for obtaining a detection image set collected from an object, and obtaining, based on the detection image set, detection feature image sets for representing a plurality of features of the object;
a processing part for inputting the detection feature image sets into the neural network, and utilizing attention mechanism modules in the neural network to carry out local attention generation and global attention generation with respect to the detection feature image sets, respectively, so as to generate processing results; and
a detection part for obtaining, based on the processing results, detection defect information of the object.

According to a fifth aspect of the present disclosure, an apparatus for training a neural network is provided that includes
a processor; and
a memory coupled to the processor, storing a computer program,
wherein, the computer program, when executed by the processor, causes the processor to carry out steps of
obtaining labeled defect information of an object and a training image set collected from the object, and obtaining, based on the training image set, feature image sets for representing a plurality of features of the object;
inputting the feature image sets into the neural network, utilizing attention mechanism modules in the neural network to carry out local attention generation and global attention generation with respect to the feature image sets, respectively, so as to obtain processing results, and calculating, based on the processing results, training defect information of the object; and
comparing the training defect information of the object and the labeled defect information of the object, so as to train the neural network and adjust parameters of the neural network.

According to a sixth aspect of the present disclosure, an apparatus for conducting defect detection by utilizing a neural network is provided that is inclusive of
a processor; and
a memory coupled to the processor, storing a computer program,
wherein, the computer program, when executed by the processor, causes the processor to carry out steps of
obtaining a detection image set collected from an object, and obtaining, based on the detection image set, detection feature image sets for representing a plurality of features of the object;
inputting the detection feature image sets into the neural network, and utilizing attention mechanism modules in the neural network to carry out local attention generation and global attention generation with respect to the detection feature image sets, respectively, so as to generate processing results; and
obtaining, based on the processing results, detection defect information of the object.

On the basis of the method and apparatus for training a neural network as well as the method and apparatus for conducting defect detection by utilizing a neural network, it is possible to perform local attention generation and global attention generation on the feature image sets of an object, respectively, thereby being capable of improving the accuracy of the image detection algorithm, reducing the computational complexity of the image detection algorithm to ensure its real-time performance, and ameliorating the user experience.

### BRIEF DESCRIPTION OF THE DRAWINGS

FIG. 1 is a flowchart of a method of training a neural network, in accordance with an embodiment of the present disclosure;

FIG. 2 is a flowchart of a method of carrying out defect detection by utilizing a neural network, in accordance with an embodiment of the present disclosure;

FIG. 3 shows a structure and processing approach of an exemplary neural network, in accordance with an embodiment of the present disclosure;

FIG. 4 represents an example of a concrete structure of a backbone network in the exemplary neural network shown in FIG. 3;

FIG. 5 illustrates an example of a concrete structure of a long short-term attention mechanism module in the exemplary neural network shown in FIG. 3;

FIG. 6 shows a structure of an exemplary ResCPE (Residual Convolutional Position Encoding) module in accordance with an embodiment of the present disclosure;

FIG. 7 represents a structure of an exemplary feature pyramid module in accordance with an embodiment of the present disclosure;

FIG. 8 illustrates an exemplary process of conducting defect detection by way of a predictor head, in accordance with an embodiment of the present disclosure;

FIG. 9 is a block diagram of an apparatus for training a neural network, in accordance with an embodiment of the present disclosure;

FIG. 10 is a block diagram of an apparatus for performing defect detection by utilizing a neural network, in accordance with an embodiment of the present disclosure;

FIG. 11 is a block diagram of another apparatus for training a neural network, in accordance with an embodiment of the present disclosure; and

FIG. 12 is a block diagram of another apparatus for conducting defect detection by utilizing a neural network, in accordance with an embodiment of the present disclosure.

### DESCRIPTION OF THE PREFERRED EMBODIMENTS

In order to let a person skilled in the art better understand the present disclosure, hereinafter, the embodiments of the present disclosure are concretely described with reference to the drawings. However, it should be noted that the same symbols, that are in the specification and drawings, stand for constituent elements having basically the same function and structure, and the repetition of the explanations to the constituent elements is omitted for the sake of convenience.

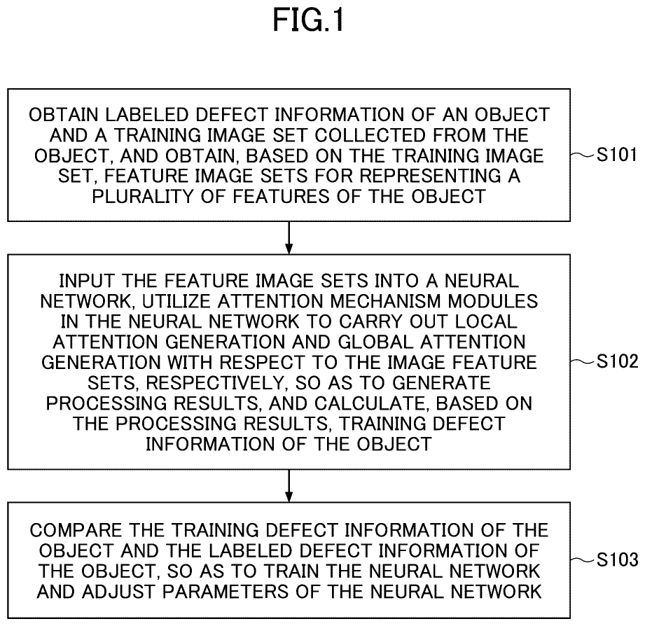

FIG. 1 is a flowchart of a method of training a neural network, in accordance with an embodiment of the present disclosure. As shown in FIG. 1, the method is inclusive of STEPS S101 to S103.

STEP S101 is obtaining labeled defect information of an object and a training image set collected from the object, and obtaining feature image sets for representing a plurality of features of the object on the basis of the training image set.

In the embodiment of the present disclosure, as an option, an object used for training may be pre-labeled with labeled defect information including defect information of the object. For example, the labeled defect information of the object may include one or more pieces of information of the defect type, defect level, defect location, and defect size of the object. Specifically, in a case where the object is the body in white of a vehicle, the defect type of the object may include, for example, one or more defects of the bulge, dent, ripple, scratch, and deformation of the body in white of the vehicle.

For example, in the defect detection process of a vehicle body in white, it is possible to adopt sinusoidal fringe imaging to collect the relevant image set of the object. In the neural network training process according to the embodiment of the present disclosure, sinusoidal fringe imaging may be utilized to obtain a training image set of the object used for training. Specifically, a plurality of sinusoidal fringes may be sequentially projected onto the surface of the object by a light source, and a camera may be utilized to collect the plurality of sinusoidal fringes projected onto the surface of the object. The phase information of the deformed fringes may be used to generate the three-dimensional information of the surface of the object, so as to make the surface features more obvious. In the embodiment of the present disclosure, it is possible to first obtain a sinusoidal fringe image set on the basis of the plurality of sinusoidal fringes projected on the surface of the object to serve as the training image set; then, obtain a depth image set and phase image set by calculating the deflection angles of the plurality of sinusoidal fringes projected on the surface of the object; and then, obtain a gradient image set and curvature image set on the basis of the depth image set by means of a gradient calculation equation and curvature calculation equation. After obtaining the various image sets, the phase image set as well as the gradient image set and curvature image set obtained from the depth image set may be used together as feature image sets (used for training) of the object. These feature image sets, i.e., the phase image set, gradient image set, and curvature image set may represent the phase, gradient, and curvature of the object, respectively. Here, it should be noted that a feature image is also called a feature map.

STEP S102 is inputting the feature image sets into the neural network, performing local attention generation and global attention generation on the feature image sets by utilizing attention mechanism modules in the neural network, respectively, so as to generate processing results, and calculating training defect information of the object on the basis of the processing results.

In the embodiment of the present disclosure, optionally, the neural network used for training and follow-on image detection may contain a plurality of network modules. For example, the neural network may include a backbone network that may be inclusive of one or more convolutional modules, down-sampling modules, and long short-term attention mechanism modules. In this option, it is possible to let the phase image set, curvature image set, and gradient image set obtained from the object pass through each module in the backbone network, respectively. Specifically, it is possible to let the feature image sets pass through the one or more convolutional modules for conducting convolutional processing, the one or more down-sampling modules for conducting down-sampling processing, and the one or more long short-term attention mechanism modules for conducting local attention generation and global attention generation. In the embodiment of the present disclosure, local attention generation refers to generating local window based self-attention, i.e., dividing an input feature image into non-overlapping windows and performing independent self-attention calculation on each window, so as to reduce the computational amount of attention. Furthermore, in the embodiment of the present disclosure, global attention generation refers to generating global self-attention, i.e., without dividing an input feature image into windows, performing self-attention calculation on the entire input feature image.

As an option, each long short-term attention mechanism module may include a plurality of modules that perform processing in parallel; for example, it may include a local feature extractor, local window attention generator, and global attention generator. In this option, it is possible to let the feature image sets pass through, in parallel, the local feature extractor for conducting fine-grained feature extraction, the local window attention generator for conducting local attention generation, and the global attention generator for conducting global attention generation, respectively.

Optionally, in the local feature extractor, an MBConv (Mobile Inverted Bottleneck Convolution) module may be used to capture the local and fine-grained features in each feature image set, so as to enrich the feature information.

In addition, as an option, in the local window attention generator, it is possible to extract global information of local window features. Specifically, it is possible to first divide each feature image in the input feature image sets into n*n local windows, and then, extract the attention of each of the non local windows. Moreover, the local window attention generator may also employ a residual convolutional position encoder to encode the positional information of the local windows, so as to make encoding more flexible and efficient.

In another example, optionally, in the global attention generator, sparse global representation information of the entire feature image set may be acquired. In this way, it is possible to reduce the computational amount, thereby enabling timely processing of high-resolution images. For example, in the global attention generator, dimensionality increase and dimensionality reduction operations may be conducted by means of a rectangular matrix S and its pseudo-inverse matrix Q, respectively, so as to reduce the computational amount of attention. The rectangular matrix S and its pseudo-inverse matrix Q may be constant matrices and computed by utilizing the Moore-Penrose approach in advance. The use of the rectangular matrix S may significantly increase the dimensionality of attention information of each of the n*n local windows, while the use of the pseudo-inverse matrix Q may significantly reduce the dimensionality of attention information of each of the n*n local windows.

After completing the parallel processing described above, the long short-term attention mechanism modules may fuse the processing results and output them to the next stage of the neural network for the follow-on processing.

In the embodiment of the present disclosure, after passing through the backbone network of the neural network, as an option, it is also possible to continue to let the phase image set, curvature image set, and gradient image set pass through feature pyramid modules for conducting up-sampling, respectively, so as to enrich the fine-grained features of the image sets, and split and stitch the processed features of these image sets. Afterwards, optionally, it is also possible to continue to carry out defect calculation and prediction by means of a predictor head, respectively. For example, after the processing of the neural network, training defect information may be obtained in regard to the object. The training defect information may include one or more pieces of information of the defect type, defect level, defect probability, defect location, and defect size of the object.

STEP S103 is training the neural network and adjusting the parameters of the neural network by comparing the training detect information of the object and the labeled defect information of the object.

In the embodiment of the present disclosure, as an option, it is possible to compare the training defect information of the object calculated by the neural network and the labeled defect information of the object obtained in advance and accordingly adjust the parameters of the neural network, so as to make the adopted loss function converge.

The embodiment of the present disclosure adopts a multimodal fusion network architecture and aggregates a plurality of pieces of modal data such as the phase image set, curvature image set, and gradient image set of the object to achieve information cross-reference and complementarity, thereby being capable of improving algorithm accuracy. In the neural network used in the embodiment of the present disclosure, it is possible to utilize, in parallel, the local feature extractor in each long short-term attention mechanism module to capture the local and fine-grained features of each feature image set of the object, so as to ensure that the output of each long short-term attention mechanism module has richer information. In this way, the algorithm accuracy may be ameliorated. Furthermore, while obtaining the long term attention of high-resolution images by means of each feature image set of the object, it is also possible to employ, in parallel, the sparse global attention generator in each long short-term attention mechanism module to obtain sparse long-distance spatial information, so as to significantly reduce the computational amount of the long short-term attention mechanism module, thereby being able to avoid missed and false detections. Specifically, in the process of generating sparse global attention, the computational amount of attention may be reduced by utilizing a rectangular matrix and its pseudo-inverse matrix.

On the basis of the method of training a neural network, in accordance with the embodiment of the present disclosure, it is possible to perform local attention generation and global attention generation on the feature image sets of an object, respectively, thereby being capable of improving the accuracy of the image detection algorithm, reducing the computational complexity of the image detection algorithm to ensure its real-time performance, and ameliorating the user experience.

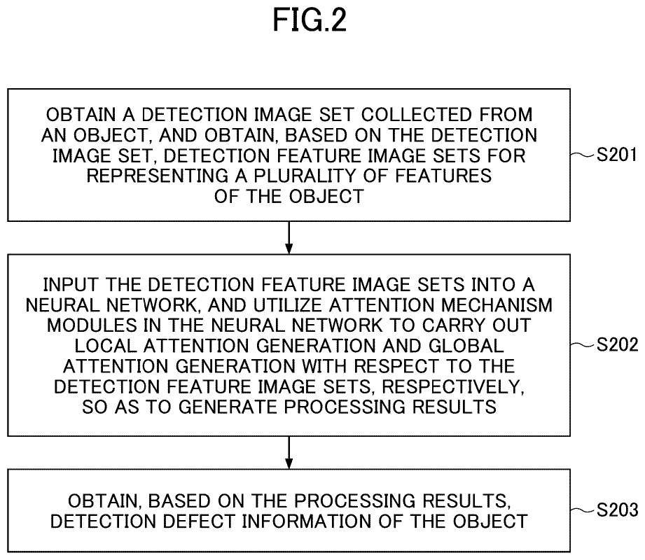

FIG. 2 is a flowchart of a method of conducting defect detection by utilizing a neural network, in accordance with an embodiment of the present disclosure. As illustrated in FIG. 2, the method is inclusive of STEPS S201 to S203. In the embodiment of the present disclosure, the neural network trained by the steps in FIG. 1 may be adopted for carrying out defect detection.

STEP S201 is obtaining a detection image set collected from an object and obtaining detection feature image sets for representing a plurality of features of the object on the basis of the detection image set.

In the embodiment of the present disclosure, optionally, it is possible to adopt sinusoidal fringe imaging to collect the relevant image set of an object to be detected. Specifically, a plurality of sinusoidal fringes may be sequentially projected onto the surface of the object by a light source, and a camera may be utilized to collect the plurality of sinusoidal fringes projected onto the surface of the object. The phase information of the deformed fringes may be used to generate the three-dimensional information of the surface of the object, so as to make the surface features more obvious. In the embodiment of the present disclosure, it is possible to first obtain a sinusoidal fringe image set on the basis of the plurality of sinusoidal fringes projected on the surface of the object to serve as the detection image set; then, obtain a detection depth image set and detection phase image set by calculating the deflection angles of the plurality of sinusoidal fringes projected on the surface of the object; and then, obtain a detection gradient image set and detection curvature image set on the basis of the detection depth image set by means of a gradient calculation equation and curvature calculation equation. After obtaining the various image sets, the detection phase image set as well as the detection gradient image set and detection curvature image set obtained from the detection depth image set may be used together as the detection feature image sets of the object. These detection feature image sets, i.e., the detection phase image set, detection gradient image set, and detection curvature image set may represent the phase, gradient, and curvature of the object, respectively.

STEP S202 is inputting the detection feature image sets into the neural network and utilizing attention mechanism modules in the neural network to perform local attention generation and global attention generation on the detection feature image sets, respectively.

In the embodiment of the present disclosure, as an option, the neural network pre-trained for image detection may contain a plurality of network modules. For example, the neural network may include a backbone network that may be inclusive of one or more convolutional modules, down-sampling modules, and long short-term attention mechanism modules. In this option, it is possible to let the detection phase image set, detection curvature image set, and detection gradient image set obtained from the object pass through each module in the backbone network, respectively. Specifically, it is possible to let the detection feature image sets pass through the one or more convolutional modules for conducting convolutional processing, the one or more down-sampling modules for conducting down-sampling processing, and the one or more long short-term attention mechanism modules for conducting local attention generation and global attention generation. Optionally, each long short-term attention mechanism module may include a plurality of modules that perform processing in parallel; for example, it may include a local feature extractor, local window attention generator, and global attention generator. In this option, it is possible to let the detection feature image sets pass through, in parallel, the local feature extractor for conducting fine-grained feature extraction, the local window attention generator for conducting local attention generation, and the global attention generator for conducting global attention generation, respectively.

As an option, in the local feature extractor, an MBConv (Mobile Inverted Bottleneck Convolution) module may be used to capture the local and fine-grained features in each detection feature image set, so as to enrich the feature information.

In addition, as an option, in the local window attention generator, it is possible to extract global information of local window features. Specifically, it is possible to first divide each feature image in the input detection feature image sets into n*n local windows, and then, extract the attention of each of the n*n local windows. Moreover, the local window attention generator may also employ a residual convolutional position encoder to encode the positional information of the local windows, so as to make encoding more flexible and efficient.

In another example, optionally, in the global attention generator, sparse global representation information of the entire detection feature image set may be acquired. In this way, it is possible to reduce the computational amount, thereby enabling timely processing of high-resolution images. For example, in the global attention generator, dimensionality increase and dimensionality reduction operations may be performed by using a rectangular matrix S and its pseudo-inverse matrix Q, respectively, so as to reduce the computational amount of attention. The rectangular matrix S and its pseudo-inverse matrix Q may be constant matrices and computed by utilizing the Moore-Penrose approach in advance. The use of the rectangular matrix S may significantly increase the attention information dimensionality of each of the n*n local windows, while the use of the pseudo-inverse matrix Q may significantly reduce the attention information dimensionality of each of the n*n local windows.

After completing the parallel processing described above, the long short-term attention mechanism modules may fuse the processing results and output them to the next stage of the neural network for the follow-on processing.

STEP S203 is obtaining detection defect information of the object on the basis of the processing results.

In the embodiment of the present disclosure, after passing through the backbone network of the neural network, as an option, it is also possible to continue to let the detection phase image set, detection curvature image set, and detection gradient image set pass through feature pyramid modules for conducting up-sampling, respectively, so as to enrich the fine-grained features of the image sets, and split and stitch the processed features of these detection feature image sets.

Afterwards, optionally, it is also possible to carry out defect calculation and prediction by means of a predictor head, respectively. For example, after the processing of the neural network, detection defect information may be obtained in regard to the object. The detection defect information may include one or more pieces of information of the defect type, defect level, defect probability, defect location, and defect size of the object.

The embodiment of the present disclosure adopts a multimodal fusion network architecture and aggregates a plurality of pieces of modal data such as the detection phase image set, detection curvature image set, and detection gradient image set of the object to achieve information cross-reference and complementarity, thereby being capable of improving algorithm accuracy. In the neural network used in the embodiment of the present disclosure, it is possible to utilize, in parallel, the local feature extractor in each long short-term attention mechanism module to capture the local and fine-grained features of each feature image set of the object, so as to ensure that the output of each long short-term attention mechanism module has richer information. In this way, the algorithm accuracy may be ameliorated. Furthermore, while obtaining the long term attention of high-resolution images by means of each feature image set of the object, it is also possible to employ, in parallel, the sparse global attention generator in each long short-term attention mechanism module to obtain sparse long-distance spatial information, so as to significantly reduce the computational amount of the long short-term attention mechanism module, thereby being able to avoid missed and false detections. Specifically, in the process of generating sparse global attention, the computational amount of attention may be reduced by utilizing a rectangular matrix and its pseudo-inverse matrix.

On the basis of the method of conducting defect detection by utilizing a neural network, it is possible to perform local attention generation and global attention generation on detection feature image sets of an object to be detected, respectively, thereby being capable of improving the accuracy of the image detection algorithm, reducing the computational complexity of the image detection algorithm to ensure its real-time performance, and ameliorating the user experience.

The following illustrates a specific implementation process of an exemplary method of training a neural network and conducting defect detection by utilizing the trained neural network, in accordance with an embodiment of the present disclosure.

In an example of the embodiment of the present disclosure, neural network training and defect detection may be performed on the surface of the body in white of a vehicle (also called a white vehicle body surface) serving as an object for training and defect detection.

In the neural network training process, it is possible to first obtain labeled defection information of the white vehicle body surface and a training image set collected from the white vehicle body surface, and then, obtain feature image sets for representing a plurality of features of the white vehicle body surface.

As an option, in the embodiment of the present disclosure, the white vehicle body surface used for training may be pre-labeled with labeled defect information including the defect information of the white vehicle body surface. For example, the labeled defect information of the white vehicle body surface may include one or more pieces of information of the defect type, defect level, defect location, and defect size of the white vehicle body surface. Specifically, the defect type of the white vehicle body surface may include, for example, one or more defects of the bulge, dent, ripple, scratch, and deformation of the white vehicle body surface.

In the defect detection process of the white vehicle body surface, it is possible to adopt sinusoidal fringe imaging to collect the relevant image set of the white vehicle body surface. In the neural network training process according to the embodiment of the present disclosure, sinusoidal fringe imaging may be utilized to obtain the training image set of the white vehicle body surface used for training. Specifically, a plurality of sinusoidal fringes may be sequentially projected onto the white vehicle body surface by a light source, and a camera may be utilized to collect the plurality of sinusoidal fringes projected onto the white vehicle body surface. The phase information of the deformed fringes may be used to generate the three-dimensional information of the white vehicle body surface, so as to make the surface features more obvious. In an example of the embodiment of the present disclosure, the application scenario of detecting defects on the white vehicle body surface may require the resolution of the on-site camera to be, for example, 4096*3000, and the actual size of the corresponding images may be 400 mm*300 mm. In the embodiment of the present disclosure, it is possible to first obtain a sinusoidal fringe image set on the basis of the plurality of sinusoidal fringes projected on the white vehicle body surface to serve as the training image set; then, obtain a depth image set and phase image set by calculating the deflection angles of the plurality of sinusoidal fringes projected on the white vehicle body surface; and then, obtain a gradient image set and curvature image set on the basis of the depth image set by means of a gradient calculation equation and curvature calculation equation. After obtaining the various image sets, the phase image set as well as the gradient image set and curvature image set obtained from the depth image set may be used together as the training feature image sets of the white vehicle body surface. These feature image sets, i.e., the phase image set, gradient image set, and curvature image set may represent the phase, gradient, and curvature of the object, respectively.

After obtaining the feature image sets used for training, in an example of the embodiment of the present disclosure, it is possible to input the feature image sets into the neural network, utilizing attention mechanism modules in the neural network to perform local attention generation and global attention generation on the feature image sets, respectively, so as to generate processing results, and calculating training defect information of the white vehicle body surface on the basis of the processing results.

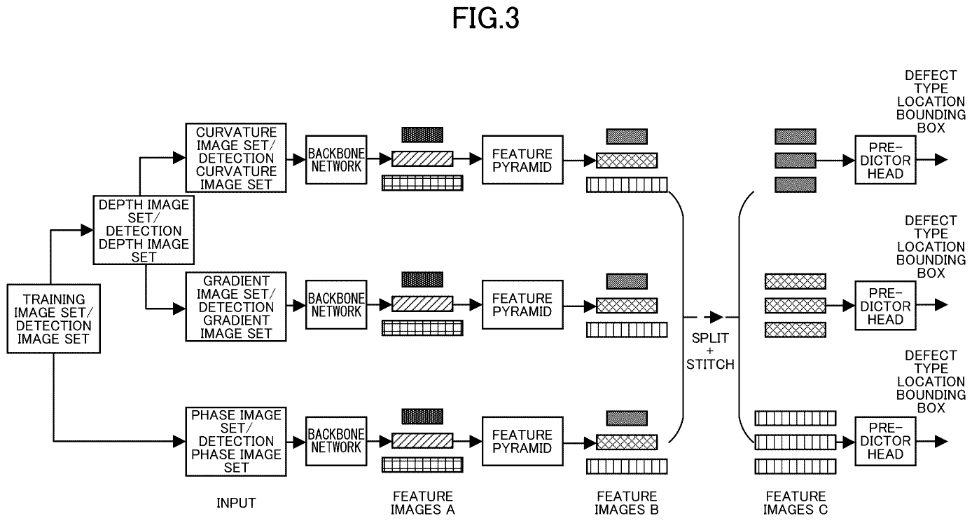

FIG. 3 shows a structure and processing approach of an exemplary neural network, in accordance with an embodiment of the present disclosure. As illustrated in FIG. 3, the neural network may include a plurality of network modules. For example, the neural network may be inclusive of a backbone network (FasterViT) and the follow-on modules such as a feature pyramid network, a predictor head, and so on.

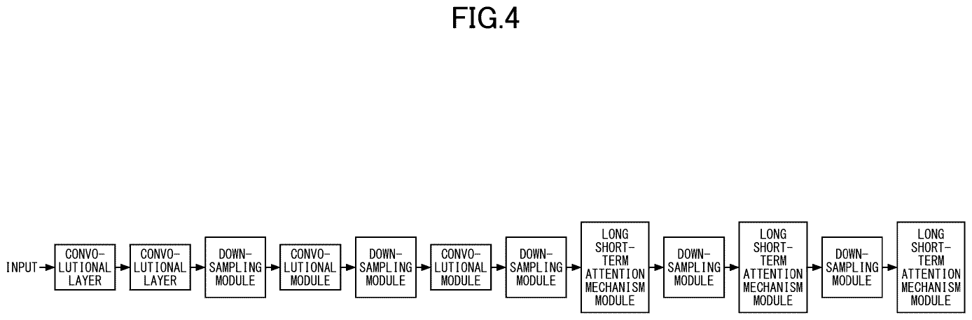

FIG. 4 represents an example of a concrete structure of the backbone network in the exemplary neural network shown in FIG. 3. As presented in FIG. 4, the backbone network may contain one or more convolutional layers, convolutional modules, down-sampling modules, and long short-term attention mechanism modules. In this example, during the process of training the neural network, it is possible to let the phase image set, curvature image set, and gradient image set collected from the object pass through each module in the backbone network, respectively. Specifically, it is possible to first send the feature image sets to two consecutive 3*3 convolutional layers that convert them into a plurality of D-dimensional feature images, respectively. Furthermore, as an option, each convolutional layer may also be followed by a BN (Batch Normalization) layer and ReLU (Rectified Linear Unit) activation function.

The stride of the second convolutional layer may be 2. Subsequently, it is also possible to continue to carry out down-sampling by means of the one or more down-sampling modules. Optionally, in order to reduce the computation amount and model size, the one or more down-sampling modules may use an average pooling layer with a stride of 2 for performing the relevant processing. Afterward, it is also possible to conduct convolution by way of the one or more convolutional modules (e.g., residual convolutional blocks).

At the end of the backbone network, it is possible to let each feature image set pass through the one or more long short-term attention mechanism modules to carry out local attention generation and global attention generation, respectively. The main function of a long short-term attention mechanism module is to provide multi-faceted information for the subsequent modules. FIG. 5 illustrates an example of a concrete structure of the long short-term attention mechanism module in the exemplary neural network shown in FIG. 3. As shown in FIG. 5, the concrete structure of the long short-term attention mechanism module may include a plurality of modules that conduct processing in parallel, such as an upper local feature extractor, a middle local window attention generator, and a lower global attention generator. In this example, it is possible to let the feature image sets pass through, in parallel, the local feature extractor for conducting fine-grained feature extraction, the local window attention generator for conducting local attention generation, and the global attention generator for conducting global attention generation, respectively.

As illustrated in FIG. 5, the local feature extractor in the long short-term mechanism module may sequentially include 1*1 convolution (Conv), 3*3 depth-wise convolution (DW Conv), and 1*1 convolution (Conv) for performing fine-grained feature extraction on the window feature images separated by the module at the previous stage, so as to enrich the feature information.

Additionally, as shown in FIG. 5, in the local window attention generator of the long short-term attention mechanism module, global information of the local windows of the output features from the previous stage may be extracted. Specifically, it is assumed that an input feature image is [symbol] ∈ [symbol] ^{H*W*d}; here, H, W, and d denote the height, width, and number of channels of the feature image, respectively. It is supposed that His equal to W (H=W). In this path, it is possible to first split the input feature map into n*n local widows. Each local window has a size of k=H/n and is represented as [symbol] as follows.

$${x}_{1} = {Split}_{k \times k} ( x )$$

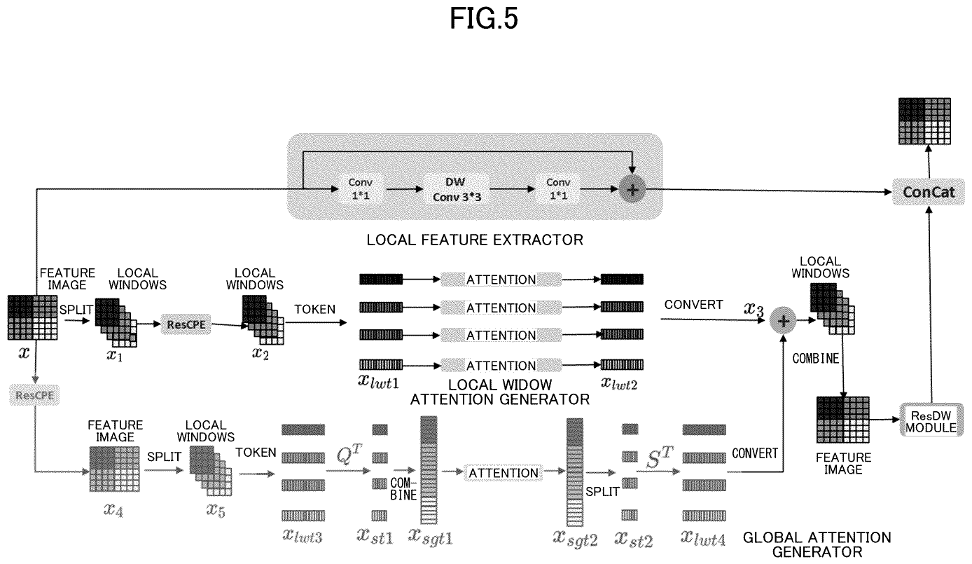

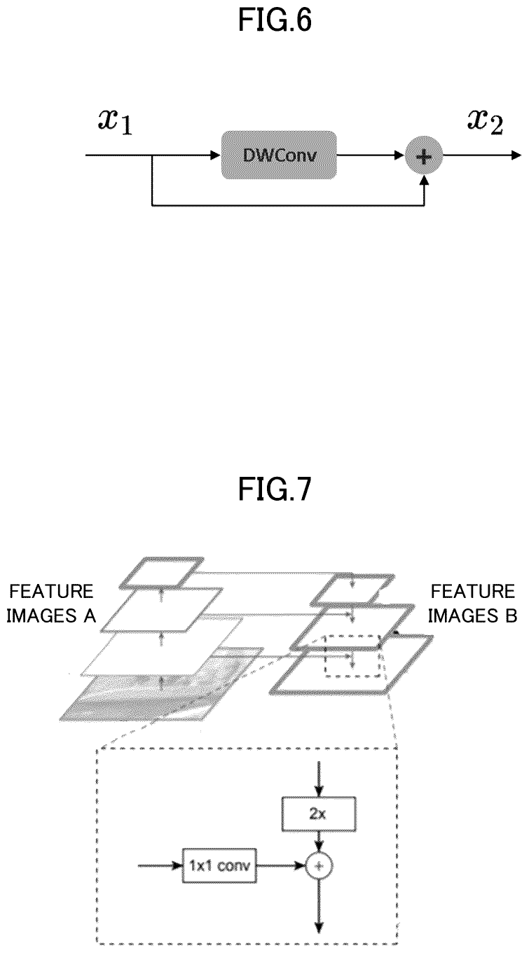

Here, [symbol] is a local window feature image. Subsequently, [symbol] is input into a residual convolutional position encoding (ResCPE) module for processing. FIG. 6 shows a structure of an exemplary ResCPE module in accordance with an embodiment of the present disclosure. As presented in FIG. 6, it is possible to add positional information to all the local window attention information by way of depth-wise separable convolution. The ResCPE module allows for more flexible and effective learning of the positional information of local windows. The output [symbol] ₂ after the processing of the ResCPE module may be represented as follows.

$${x}_{2} = ResCPE \{ {x}_{1} \}$$

Afterwards, each local window may be flattened into a two-dimensional vector named a local window tag [symbol] _{lwt1}, and each [symbol] _{lwt1} is sent to a self-attention module to obtain [symbol] _{lwt2}, respectively. Eventually, [symbol] _{lwt2} is converted back into a local window feature image [symbol] ₃, and [symbol] ₃ possesses the global information of the local window feature image.

In addition, the global attention generator in the long short-term attention mechanism module may be responsible for obtaining a rough global representation of the entire feature map. This helps to significantly reduce the computational amount, thereby enabling the algorithm to process high-resolution images in real time.

In the global attention generator, firstly, x may be fed into the ResCPE module to obtain a feature image [symbol] ₄. Similar to the above, the ResCPE module is responsible for learning the positional information of the entire feature image. Secondly, [symbol] ₄ is divided into non local windows [symbol] ₅. Each local window in [symbol] ₅ is flattened into a two-dimensional vector [symbol] _{lwt3}∈ [symbol] ^{k}^{²}^{×C}

Next, it is possible to obtain a sparse local window token [symbol] ₛₜ₁∈ [symbol] ^{L×C} as follows.

$${x}_{st 1} = {Q}^{T} {x}_{lwt 3}$$

Here, Q∈ [symbol] ^{k}^{²}^{×L} is a conversion matrix, L<<k², and C is the number of channels. The main purpose of the above processing is to reduce the number of tags from k² to L, thereby significantly reducing the computational amount of the long short-term attention mechanism module.

Subsequently, it is possible to merge each [symbol] ₛₜ₁ into a sparse global tag [symbol] _{sgt1} as follows.

$${x}_{sgt 1} = merge ( {x}_{st 1} )$$

By using the attention module to process [symbol] _{sgt1}, it is possible to ultimately obtain the sparse long-distance spatial information [symbol] _{sgt2} in the entire feature image as follows.

$${x}_{sgt 2} = attention ( {x}_{sgt 1} )$$

Afterwards, a dimensionality increase operation may be conducted as follows.

$${x}_{st 2} = split ( {x}_{sgt 2} )$$

$${x}_{lwt 4} = {S}^{T} {x}_{st 2}$$

Here, Q is a matrix that is the pseudo-inverse matrix of the matrix S. In an example of the embodiment of the present disclosure, the matrix S may be a rectangular matrix, and Q is its pseudo-inverse. In the global attention generator, dimensionality increase and dimensionality reduction operations may be performed by using the rectangular matrix S and its pseudo-inverse matrix Q, respectively, so as to reduce the computational amount of attention. Optionally, the matrices S and Q may be constant matrices, and they may be pre-computed by using, for example, the Moore-Penrose approach before conducting neural network training and defect detection.

After completing the parallel processing described above, the long short-term attention mechanism modules may fuse the processing results and output them to the next stage of the neural network for the follow-on processing. For example, as shown in FIG. 5, it is possible to convert each [symbol] _{lwt4} back into a local window feature map and combine with [symbol] ₃ to merge all the local window maps into an entire feature image that contains the long-distance spatial information of the entire feature image. Finally, it is possible to combine, in connection with the processing results of the local feature extractors, all the feature images to obtain the output information of the long short-term attention mechanism modules.

In the embodiment of the present disclosure, after passing through the backbone network of the neural network, optionally, as illustrated in FIG. 3, it is also possible to continue to let the processing results (feature images A) of the phase image set, curvature image set, and gradient image set pass through feature pyramid modules for conducting up-sampling, respectively, so as to acquire fine-grained feature enriched images (feature images B). FIG. 7 represents a structure of an exemplary feature pyramid module in accordance with an embodiment of the present disclosure. As shown in FIG. 7, it is possible to process the feature images A by means of 1*1 convolution and 2× up-sampling to acquire the feature images B.

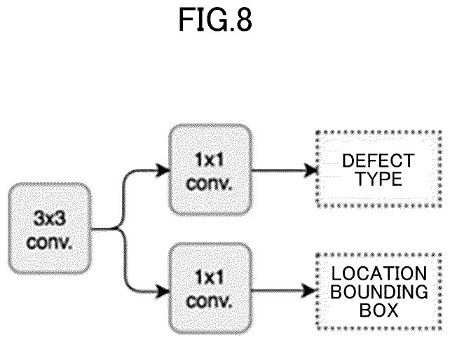

Afterwords, it is possible to split and stitch the processed features of these image sets, so as to obtain feature images C, and then, conduct defect calculation and prediction by way of a predictor head, respectively, so as to obtain a calculation result relating to, for example, the defect type and defect location. FIG. 8 illustrates an exemplary process of conducting defect detection by way of a predictor head, in accordance with an embodiment of the present disclosure. As presented in FIG. 8, relevant information about the defect type and defect location bounding box may be output through 3*3 convolution and 1*1 convolution, respectively. Optionally, the output training defect information may also include one or more pieces of information of the defect level, defect probability and defect size of the object.

In an example of the embodiment of the present disclosure, the training process of the neural network may include comparing the training defect information of the object with the labeled defect information of the object to train the neural network and adjust the parameters of the neural network.

Optionally, the training defect information of the object obtained by the neural network may be compared with the pre-obtained labeled defect information of the object, and the various parameters of the neural network may be adjusted accordingly to make the adopted loss function converge.

After training the neural network, in an example of the embodiment of the present disclosure, the trained neural network may optionally be utilized to detect defects on a white vehicle body surface.

In the defect detection process, it is agreed that the neural network shown in FIG. 3 may be used to input the detection feature image sets and output the defect type and defect location bounding box. The operating principle of the neural network is similar to the examples above and not repeated for the sake of convenience.

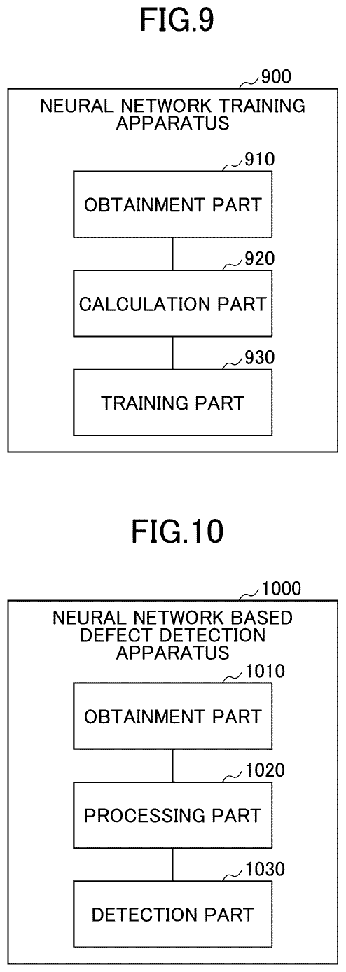

Hereinafter, with reference to FIG. 9, an apparatus for training a neural network, in accordance with an embodiment of the present disclosure is described. FIG. 9 illustrates a block diagram of an apparatus 900 for training the neural network, in accordance with the embodiment of the present disclosure. As shown in FIG. 9, the apparatus 900 is inclusive of an obtainment part 910, calculation part 920, and training part 930. In addition to these, the apparatus 900 may also include other components; however, because these components are not directly relevant to the contents of the embodiment of the present disclosure, their illustrations and descriptions are omitted here.

The apparatus 900 may be configured to execute the method of training a neural network described above with reference to FIG. 1. Concretely, the obtainment part 910, calculation part 920, and training part 930 may be configured to perform STEPS S101 to S103 of FIG. 1, respectively. Here, it should be noted that for the reason that STEPS S101 to S103 of FIG. 1 have been minutely described in the above embodiment, the details of them are omitted in the embodiment of the present disclosure. In addition, the apparatus 900 may also achieve the same technical effect as the method described above with reference to FIG. 1.

In what follows, by referring to FIG. 10, an apparatus for conducting defect detection by utilizing a neural network, in accordance with an embodiment of the present disclosure is described. FIG. 10 shows a block diagram of an apparatus 1000 for performing defect detection by utilizing the neural network, in accordance with the embodiment of the present disclosure. As shown in FIG. 10, the apparatus 1000 is inclusive of an obtainment part 1010, processing part 1020, and detection part 1030. In addition to these, the apparatus 1000 may also include other components; however, because these components are not directly relevant to the contents of the embodiment of the present disclosure, their illustrations and descriptions are omitted here.

The apparatus 1000 may be configured to execute the method of conducting defect detection by utilizing a neural network described above by referring to FIG. 2. Specifically, the obtainment part 1010, processing part 1020, and detection part 1030 may be configured to perform STEPS S201 to S203 of FIG. 2, respectively. Here, it should be noted that for the reason that STEPS S201 to S203 of FIG. 2 have been minutely described in the above embodiment, the details of them are omitted in the embodiment of the present disclosure. In addition, the apparatus 1000 may also achieve the same technical effect as the method described above by referring to FIG. 2.

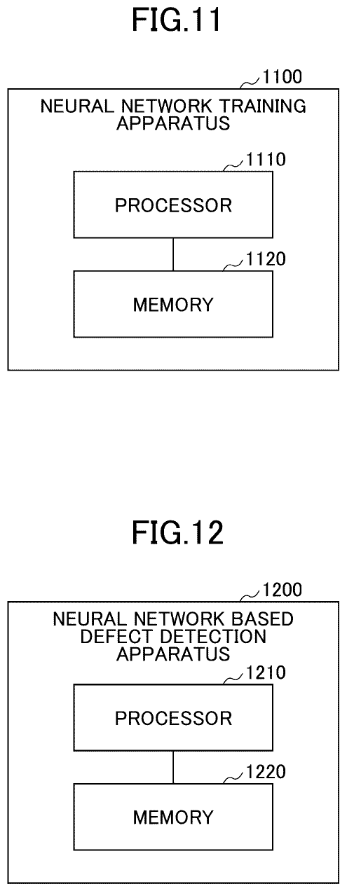

Hereinafter, with reference to FIG. 11, another apparatus for training a neural network, in accordance with an embodiment of the present disclosure is described. FIG. 11 illustrates a block diagram of an apparatus 1100 for training the neural network, in accordance with the embodiment of the present disclosure. The apparatus 1100 may be a computer or server, for example. As shown in FIG. 11, the apparatus 1100 is inclusive of a processor(s) 1110 and a memory 1120. Of course, in addition to these, the apparatus 1100 may also include an input unit, an output unit (not shown), etc., and these components may be interconnected via a bus system and/or other forms of connection mechanisms. Here, it should be noted that the components and structure of the apparatus 1100 presented in FIG. 11 are merely exemplary ones, and the apparatus 1100 may also have other components and structures as needed.

The processor(s) 1110 may be a central processing unit (CPU) or other processing unit with data processing and/or instruction execution capabilities; that is, the processor(s) 1110 may adopt any one of the conventional processors in the related art. The memory 1120 may include various forms of computer-readable storage media, such as a volatile memory, non-volatile memory, and the like; in other words, the memory 1120 may utilize any one of the existing storages in the related art. Computer program instructions (i.e., a computer program) for executing the method of training a neural network described above with reference to FIG. 1 as well as various application programs and data may be stored in the memory 1120. The processor(s) 1110 may be configured to execute the computer program stored in the memory 1120 to achieve the method described above with reference to FIG. 1. Concretely, the processor(s) 1110 may be configured to execute the computer program stored in the memory 1120 to fulfill STEPS S101 to S103 of FIG. 1, respectively. Here, it should be noted that for the reason that STEPS S101 to S103 of FIG. 1 have been minutely described in the above embodiment, the details of them are omitted in the embodiment of the present disclosure. In addition, the apparatus 1100 may also achieve the same technical effect as the method described above with reference to FIG. 1.

In what follows, by referring to FIG. 12, another apparatus for conducting defect detection by utilizing a neural network, in accordance with an embodiment of the present disclosure is described. FIG. 12 shows a block diagram of an apparatus 1200 for conducting defect detection by utilizing the training the neural network, in accordance with the embodiment of the present disclosure. The apparatus 1200 may be a computer or server, for example. As presented in FIG. 12, the apparatus 1200 is inclusive of a processor(s) 1210 and a memory 1220. Of course, in addition to these, the apparatus 1200 may also include an input unit, an output unit (not shown), etc., and these components may be interconnected via a bus system and/or other forms of connection mechanisms. Here, it should be noted that the components and structure of the apparatus 1200 shown in FIG. 12 are merely exemplary ones, and the apparatus 1200 may also have other components and structures as needed.

The processor(s) 1210 may be a central processing unit (CPU) or other processing unit with data processing and/or instruction execution capabilities; that is, the processor(s) 1210 may adopt any one of the conventional processors in the related art. The memory 1220 may include various forms of computer-readable storage media, such as a volatile memory, non-volatile memory, and so on; in other words, the memory 1220 may utilize any one of the existing storages in the related art. Computer program instructions (i.e., a computer program) for executing the method of conducting defect detection by utilizing a neural network described above by referring to FIG. 2 as well as various application programs and data may be stored in the memory 1220. The processor(s) 1210 may be configured to execute the computer program stored in the memory 1220 to achieve the method described above by referring to FIG. 2. Concretely, the processor(s) 1210 may be configured to execute the computer program stored in the memory 1220 to fulfill STEPS S201 to S203 of FIG. 2, respectively. Here, it should be noted that for the reason that STEPS S201 to S203 of FIG. 2 have been minutely described in the above embodiment, the details of them are omitted in the embodiment of the present disclosure. In addition, the apparatus 1200 may also achieve the same technical effect as the method described above with reference to FIG. 2.

Moreover, a computer-executable program (i.e., a computer program) and non-transitory computer-readable medium are provided according to an embodiment of the present disclosure. The computer program may cause a computer to perform the method of training a neural network and the method of conducting detect detection by utilizing a neural network, in accordance with the above embodiments. The non-transitory computer-readable medium may store a computer-executable program (i.e., a computer program) for execution by a computer involving a processor(s). The computer program may, when executed by the processor(s), cause the processor(s) to execute the method of training a neural network and the method of conducting detect detection by utilizing a neural network, in accordance with the above embodiments.

Here, it should be pointed out that the above embodiments are just exemplary ones, and the specific structure and operation of them are not be used for limiting the present disclosure.

In addition, the embodiments of the present disclosure may be implemented in any convenient form, for example, using dedicated hardware or a mixture of dedicated hardware and software. The embodiments of the present disclosure may be implemented as computer software executed by one or more networked processing apparatuses. The network may include any conventional terrestrial or wireless communications network, such as the Internet, and the like. The processing apparatuses may include any suitably programmed apparatuses such as a general-purpose computer, a personal digital assistant, a mobile telephone (such as a WAP or 3G, 4G, or 5G-compliant phone), and so on. Because the embodiments of the present disclosure may be implemented as software, each and every aspect of the present disclosure thus encompasses computer software implementable on a programmable device.

The computer software may be provided to the programmable device using any storage medium for storing processor-readable code such as a floppy disk, a hard disk, a CD ROM, a magnetic tape device, a solid state memory device, and so forth.

The related hardware platform may include any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present disclosure is described with reference to the specific embodiments chosen for purpose of illustration, it should be apparent that the present disclosure is not limited to these embodiments, but numerous modifications may be made thereto by a person skilled in the art without departing from the basic concept and technical scope of the present disclosure.

What is claimed is:

1. A method of training a neural network, comprising:
obtaining labeled defect information of an object and a training image set collected from the object, and obtaining, based on the training image set, feature image sets for representing a plurality of features of the object;
inputting the feature image sets into the neural network, utilizing attention mechanism modules in the neural network to carry out local attention generation and global attention generation with respect to the feature image sets, respectively, so as to generate processing results, and creating, based on the processing results, training defect information of the object; and
comparing the training defect information of the object and the labeled defect information of the object, so as to train the neural network and adjust parameters of the neural network.

2. The method according to claim 1, wherein,
the obtaining the labeled defect information of the object and the training image set collected from the object, and obtaining, based on the training image set, the feature image sets for representing the plurality of features of the object includes
obtaining, based on a plurality of sinusoidal fringes projected onto the object, a sinusoidal fringe image set serving as the training image set; and
obtaining, based on the sinusoidal fringe image set, a phase image set and a depth image set of the object, calculating, based on the depth image set, a curvature image set and a gradient image set of the object, and causing the phase image set, the curvature image set and the gradient image set to be the feature image sets.

3. The method according to claim 1, wherein,
the inputting the feature image sets into the neural network, utilizing the attention mechanism modules in the neural network to carry out local attention generation and global attention generation with respect to the feature image sets, respectively, so as to generate the processing results, and creating, based on the processing results, the training defect information of the object includes
causing the feature image sets to pass through one or more convolutional modules in the neural network for conducting convolutional processing, one or more down-sampling modules in the neural network for conducting down-sampling processing, and one or more long short-term attention mechanism modules in the neural network for conducting local attention generation and global attention generation.

4. The method according to claim 3, wherein,
the inputting the feature image sets into the neural network, utilizing the attention mechanism modules in the neural network to carry out local attention generation and global attention generation with respect to the feature image sets, respectively, so as to generate the processing results, and creating, based on the processing results, the training defect information of the object further includes
causing the feature image sets to pass through, in parallel, local feature extractors, local window attention generators, and global attention generators of the one or more long short-term attention mechanism modules in the neural network for conducting processing, respectively, wherein, the feature image sets are processed by the local feature extractors for fine-grained feature extraction, the local window attention generators for local attention generation, and the global attention generators for global attention generation, and the one or more long short-term attention mechanism modules then fuse the processing results.

5. The method according to claim 4, wherein,
the global attention generators carry out a dimensionality increase operation and a dimensionality reduction operation by means of a rectangular matrix S and its pseudo-inverse matrix Q, respectively.

6. The method according to claim 1, wherein,
the labeled defect information and/or the training defect information include one or more pieces of information of a defect type, defect level, defect location, and defect size of the object.

7. The method according to claim 6, wherein,
the defect type of the object includes one or more defects of a bulge, dent, ripple, scratch, and deformation of the object.

8. An apparatus for training a neural network, comprising:
a processor; and
a memory coupled to the processor, storing a computer program,
wherein, the computer program causes, when executed by the processor, the processor to implement
obtaining labeled defect information of an object and a training image set collected from the object, and obtaining, based on the training image set, feature image sets for representing a plurality of features of the object;
inputting the feature image sets into the neural network, utilizing attention mechanism modules in the neural network to carry out local attention generation and global attention generation with respect to the feature image sets, respectively, so as to generate processing results, and creating, based on the processing results, training defect information of the object; and
comparing the training defect information of the object and the labeled defect information of the object, so as to train the neural network and adjust parameters of the neural network.

9. The method according to claim 8, wherein,
the obtaining the labeled defect information of the object and the training image set collected from the object, and obtaining, based on the training image set, the feature image sets for representing the plurality of features of the object includes
obtaining, based on a plurality of sinusoidal fringes projected onto the object, a sinusoidal fringe image set serving as the training image set; and
obtaining, based on the sinusoidal fringe image set, a phase image set and a depth image set of the object, calculating, based on the depth image set, a curvature image set and a gradient image set of the object, and causing the phase image set, the curvature image set and the gradient image set to be the feature image sets.

10. The method according to claim 8, wherein,
the inputting the feature image sets into the neural network, utilizing the attention mechanism modules in the neural network to carry out local attention generation and global attention generation with respect to the feature image sets, respectively, so as to generate the processing results, and creating, based on the processing results, the training defect information of the object includes
causing the feature image sets to pass through one or more convolutional modules in the neural network for conducting convolutional processing, one or more down-sampling modules in the neural network for conducting down-sampling processing, and one or more long short-term attention mechanism modules in the neural network for conducting local attention generation and global attention generation.

11. The method according to claim 10, wherein,
the inputting the feature image sets into the neural network, utilizing the attention mechanism modules in the neural network to carry out local attention generation and global attention generation with respect to the feature image sets, respectively, so as to generate the processing results, and creating, based on the processing results, the training defect information of the object further includes
causing the feature image sets to pass through, in parallel, local feature extractors, local window attention generators, and global attention generators of the one or more long short-term attention mechanism modules in the neural network for conducting processing, respectively, wherein, the feature image sets are processed by the local feature extractors for fine-grained feature extraction, the local window attention generators for local attention generation, and the global attention generators for global attention generation, and the one or more long short-term attention mechanism modules then fuse the processing results.

12. The method according to claim 11, wherein,
the global attention generators carry out a dimensionality increase operation and a dimensionality reduction operation by means of a rectangular matrix S and its pseudo-inverse matrix Q, respectively.

13. The method according to claim 8, wherein,
the labeled defect information and/or the training defect information include one or more pieces of information of a defect type, defect level, defect location, and defect size of the object.

14. The method according to claim 13, wherein,
the defect type of the object includes one or more defects of a bulge, dent, ripple, scratch, and deformation of the object.

15. A method of conducting defect detection by utilizing a neural network, comprising:
obtaining a detection image set collected from an object, and obtaining, based on the detection image set, detection feature image sets for representing a plurality of features of the object;
inputting the detection feature image sets into the neural network, and utilizing attention mechanism modules in the neural network to carry out local attention generation and global attention generation with respect to the detection feature image sets, respectively, so as to generate processing results; and
obtaining, based on the processing results, detection defect information of the object.

16. The method according to claim 15, wherein,
the obtaining the detection image set collected from the object, and obtaining, based on the detection image set, the detection feature image sets for representing the plurality of features of the object includes
obtaining, based on a plurality of sinusoidal fringes projected onto the object, a sinusoidal fringe image set serving as the detection image set; and
obtaining, based on the sinusoidal fringe image set, a phase image set and a depth image set of the object, calculating, based on the depth image set, a curvature image set and a gradient image set of the object, and causing the phase image set, the curvature image set and the gradient image set to be the detection feature image sets.

17. The method according to claim 15, wherein,
the inputting the detection feature image sets into the neural network, and utilizing the attention mechanism modules in the neural network to carry out local attention generation and global attention generation with respect to the detection feature image sets, respectively, so as to generate the processing results includes
causing the detection feature image sets to pass through one or more convolutional modules in the neural network for conducting convolutional processing, one or more down-sampling modules in the neural network for conducting down-sampling processing, and one or more long short-term attention mechanism modules in the neural network for conducting local attention generation and global attention generation.

18. The method according to claim 17, wherein,
the inputting the detection feature image sets into the neural network, and utilizing the attention mechanism modules in the neural network to carry out local attention generation and global attention generation with respect to the detection feature image sets, respectively, so as to generate the processing results further includes
causing the detection feature image sets to pass through, in parallel, local feature extractors, local window attention generators, and global attention generators of the one or more long short-term attention mechanism modules in the neural network for conducting processing, respectively, wherein, the detection feature image sets are processed by the local feature extractors for fine-grained feature extraction, the local window attention generators for local attention generation, and the global attention generators for global attention generation, and the one or more long short-term attention mechanism modules then fuse the processing results.

19. The method according to claim 18, wherein,
the global attention generators carry out a dimensionality increase operation and a dimensionality reduction operation by means of a rectangular matrix S and its pseudo-inverse matrix Q, respectively.

20. The method according to claim 15, wherein,
the detection defect information includes one or more pieces of information of a defect type, defect level, defect location, and defect size of the object.
